(19) United States
(12) Patent Application Publication
(10) Pub. No.: US 2025/0375025 A1
(43) Pub. Date: Dec. 11, 2025

(54) MODULAR TOOL CARRIER

(71) Applicant: Todd A. Triplett, Floyds Knobs, IN (US)

(72) Inventor: Todd A. Triplett, Floyds Knobs, IN (US)

(21) Appl. No.: 19/233,401

(22) Filed: Jun. 10, 2025

Related U.S. Application Data
(60) Provisional application No. 63/658,065, filed on Jun. 10, 2024.

(51) Int. Cl. A45F 5/00; A41D 1/04; A45F 5/02; A62B 3/00

(52) U.S. Cl. CPC A45F 5/1575; A45F 5/022; A41D 1/04; A62B 3/005

(57) ABSTRACT

This disclosure relates to a modular tool carrier for use in tactical environments. The modular tool carrier includes a backplate assembly configured for attachment to a tactical vest and a tool holder removably attachable to the backplate assembly.

### CROSS-REFERENCE TO RELATED APPLICATION

This application claims priority to U.S. Provisional Application No. 63/658,065, filed Jun. 10, 2024, incorporated herein by reference.

### FIELD

This disclosure relates to a modular tool carrier for use in tactical environments. The modular tool carrier includes a backplate assembly configured for attachment to a tactical vest and a tool holder removably attachable to the backplate assembly.

### BACKGROUND

Breaching and breaking tools can include halligan bars, crowbars, pry bars, sledgehammers, axes, rams, bolt cutters, and lock breakers. These tools are often used during tactical law enforcement and military operations, as well as during fire and rescue operations. Users need the ability to retain their tools for ready availability, but also preferably need to keep their hands free. Users also need the ability to comfortably sit for an extended period of time within a vehicle, such as an armored rescue vehicle, while still having ready access to their tools.

Some existing tool carriers are rigid constructions mounted on the rear of tactical vests. Such carriers tend to be incompatible with extended periods of sitting within a vehicle, as the carrier protrudes from the rear of the vest and prevents the wearer from resting against the seat back. Also, the tool may jostle within the rigid holder and distract the wearer. Furthermore, rigid tool carriers mounted on the rear of a tactical vest are typically not readily accessible by the wearer and require a second individual to remove and stow the tool once it is no longer needed.

Other existing tool carriers are pliable sleeve-like constructions. Such carriers tend to allow quick access to a tool and be more comfortable to wear than rigid carriers, but may quickly become worn or collapse from ordinary use—such as when compressed by the bodyweight of a wearer sitting and leaning back against a seat. Once a pliable sleeve-like carrier becomes worn or collapses, it can be difficult to insert a tool back into the carrier.

One homemade solution to carry breaching and breaking tools is to cut a length of firehose and attach it to a tactical vest using paracord, zip ties, or other means. Another homemade solution is to cut a length of PVC pipe to an appropriate size, such as, for example, a three inch diameter pipe with a length of six inches, drill several holes in the pipe, then weave paracord through the holes and tie the pipe to a tactical vest. While both solutions are economical, the first suffers the same disadvantages as other pliable, sleeve-like constructions and the latter suffers the same disadvantages as other rigid constructions, and both are permanently attached to the tactical vest until cut off.

A need exists for a means for carrying a comparatively large and bulky breaching or breaking tool which allows the tool to be quickly and reliably loaded onto the wearer and retrieved from the wearer, while still allowing the wearer to comfortably sit for extended periods of time. Certain features of the present invention address these and other needs and provide other important advantages.

### SUMMARY

Embodiments of the present disclosure include a modular tool carrier including a a tool holder having a holster attachment plate with a substantially flat front surface, a substantially flat rear surface, a top, a bottom, and two sides extending between the front surface and the rear surface. The modular tool carrier further includes a holster having at least one back wall, said back wall having a substantially flat front surface and a substantially flat rear surface. The holster further includes two spaced apart sidewalls extending substantially perpendicular from the at least one back wall, and extending parallel to each other, with the sidewalls being connected by a convex front portion extending between the sidewalls. The holster is attached to the holster attachment plate and the front surface of the holster attachment plate, and the sidewalls and the convex front portion of the holster cooperatively form a channel for holding a tool.

The modular tool carrier may further include a backplate assembly including a backplate body having a substantially flat front surface, a substantially flat rear surface, at least one side extending between the front surface and the rear surface, and two spaced apart rails on the front surface. The rails extend parallel to each other and are configured to removably receive and slidably engage the sides of the holster attachment plate.

The backplate assembly of the modular tool carrier may further include at least one mounting member attached to the rear surface of the backplate body. The at least one mounting member may further include a first elongated member and a second elongated member. The first and second elongated members may be hingedly attached at a first end of the mounting member and may be configured to mechanically engage at a second end of the mounting member opposite the first end. The first elongated member may further include a bar-shaped member and the second elongated member may include a hook-shaped member, with the hook shaped member of the second elongated member mechanically engaging the bar-shaped member of the first elongated member. The first elongated member may further include at least one spring-loaded release button that mechanically disengages the hook element from the bar element when depressed by a user. The backplate body may further include at least one aperture, and the at least one mounting member may include, for each aperture in the backplate body, a corresponding aperture in the at least one mounting member. A fastener extending into the aperture in the backplate body and the corresponding aperture in the at least one mounting member may mechanically secure the at least one mounting member to the backplate body.

The holster attachment plate may further include a retaining element extending past the bottom of the holster attachment plate. The retaining element may include a raised block on the rear surface of the retaining element.

The holster of the tool holder may further include a protrusion extending from the convex front portion of the tool holder. The protrusion may comprise a horizontal channel configured to receive a length of cordage.

The sides of the holster attachment plate of the tool holder may further include a lower portion adjacent the bottom of the holster attachment plate and an upper portion adjacent the top of the holster attachment plate, with the width of the upper portion being greater than the width of the lower portion. The holster attachment plate may further include an interface between the lower portion and the upper portion that creates a stop that contacts the rails of the backplate.

The front surface of the holster attachment plate may further include a protrusion extending from the front surface of the holster attachment plate. The protrusion may comprise a horizontal channel configured to receive a length of cordage.

The holster of the tool holder may further include a protrusion extending from the convex front portion of the tool holder, and the front surface of the holster attachment plate may further include a protrusion extending from the front surface of the holster attachment plate. The protrusion extending from the convex front portion of the tool holder and the protrusion extending from the front surface of the holster attachment plate may each comprise a horizontal channel configured to receive a length of cordage.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present invention will become apparent to one of ordinary skill in the art from the detailed description and drawings contained herein. Moreover, it will be appreciated that the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

Some of the figures shown herein may include dimensions or may have been created from scaled drawings. However, such dimensions, or the relative scaling within a figure, are by way of example only, and are not to be construed as limiting the scope of this invention.

FIG. 1 is a front isometric view of a first embodiment of a modular tool carrier.

FIG. 2 is a rear isometric view of the modular tool carrier of FIG. 1.

FIG. 3 is an exploded view of the modular tool carrier of FIG. 1.

FIG. 4 is a front isometric view of a backplate of the modular tool carrier of FIG. 1.

FIG. 5 is a front view of the backplate of FIG. 4.

FIG. 6 is a front isometric view of a backplate assembly of the modular tool carrier of FIG. 1.

FIG. 7 is a is a rear isometric view of the backplate assembly of FIG. 6.

FIG. 8 is a front isometric view of a tool holder of the module tool carrier of FIG. 1.

FIG. 9 is a rear isometric view of the tool holder of FIG. 8.

FIG. 10 is a front isometric view of a holster of the tool holder of FIG. 8.

FIG. 11 is a front view of a holster attachment plate of the tool holder of FIG. 8.

FIG. 12 is a rear perspective view of the holster attachment plate of FIG. 11.

FIG. 13 is a front isometric view of a second embodiment of a modular tool carrier.

FIG. 14 is a front isometric view of a holster of the modular tool carrier of FIG. 13.

### DETAILED DESCRIPTION OF THE ILLUSTRATED EMBODIMENTS

For the purposes of promoting an understanding of the principles of the invention disclosed herein, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated. When used with a numerical value, the terms “about,” “approximately,” or “substantially” mean, unless otherwise specified, a range of numerical values within ten percent of the most precise significant digit in the stated value. For example “about 10” means the range from 9 to 11, while “about 10.0” means the range from 9.9 to 10.1. Similarly, the terms when used with a textual description of a numerical parameter, such as “substantially perpendicular” means an angle within ten percent of 90 degrees to a given surface (e.g., 81 degrees to 99 degrees).

Reference systems that may be used herein can refer generally to various directions, which are merely offered to assist the reader in understanding the various embodiments of the disclosure and are not to be interpreted as limiting. Other reference systems may be used to describe various embodiments. This document describes an embodiment of a modular tool carrier attached to the rear or backside of a tactical vest worn by an individual, wherein the “rear” of the modular tool carrier attaches to the rear of the tactical vest and the tool is carried on the wearer's back with the “top” of the carrier being oriented closest to the wearer's head. It should be understood that a modular tool carrier may be attached to a harness, backpack or other wearable load-bearing element other than a tactical vest and may be attached to the wearer in various orientations, such that the rear of the modular tool carrier is positioned on the wearer's chest, shoulder or arm instead of the wearer's back.

The following legend relates to the numbers shown in the drawings: 10, 100—modular tool carrier; 12—backplate assembly; 14—tool holder; 16—backplate; 18—mounting member; 20—holster attachment plate; 22—holster; 24—front surface; 26—rear surface; 28—side; 30—top; 32—bottom; 34—rails; 36—groove; 38—first elongated element; 40—second elongated element; 42—rear surface; 44—aperture; 45—aperture; 46—aperture; 48—first end; 50—second end; 52—hook element; 54—bar element; 56—front surface; 58—rear surface; 60—top; 62—bottom; 64—sides; 66—lower portion; 68—upper portion; 70—stop; 72—retaining element; 74—raised block; 76—back wall; 78—front surface; 80—rear surface; 82—aperture; 84—aperture; 86—sidewall; 88—convex front portion; 90—vertical channel; 92—saddle shape; 94—first cordage attachment plate; 96—aperture; 98—horizontal channel; 102—second cordage attachment plate; 104—horizontal channel; and 106—rope.

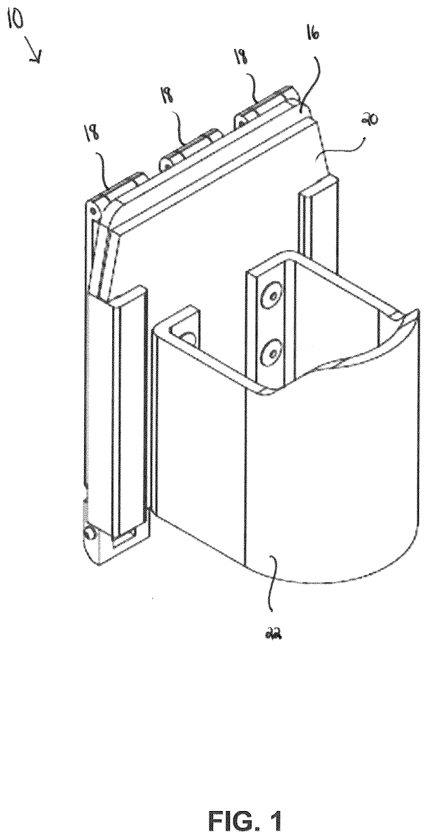

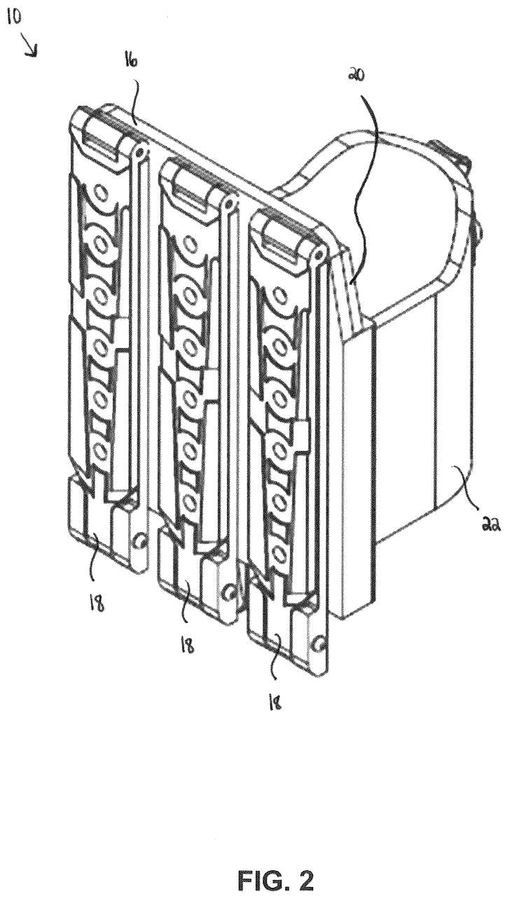

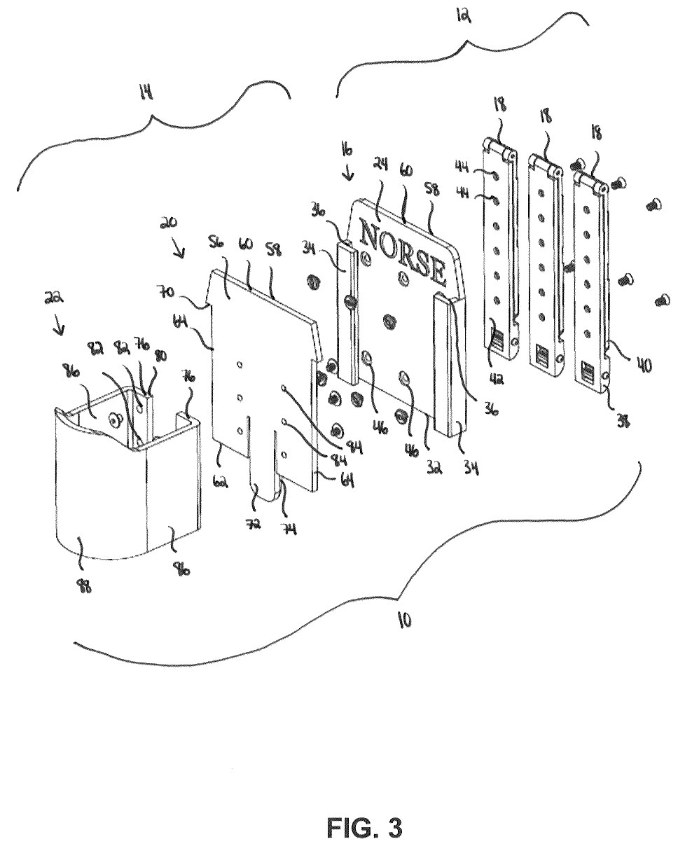

A first embodiment of a modular tool carrier 10 includes a backplate assembly 12 and a tool holder 14 removably attached to the backplate assembly 12. Referring now to FIGS. 1-3, the backplate assembly 12 includes a backplate 16 and at least one mounting member 18. The tool holder 14 includes a holster attachment plate 20 and a holster 22.

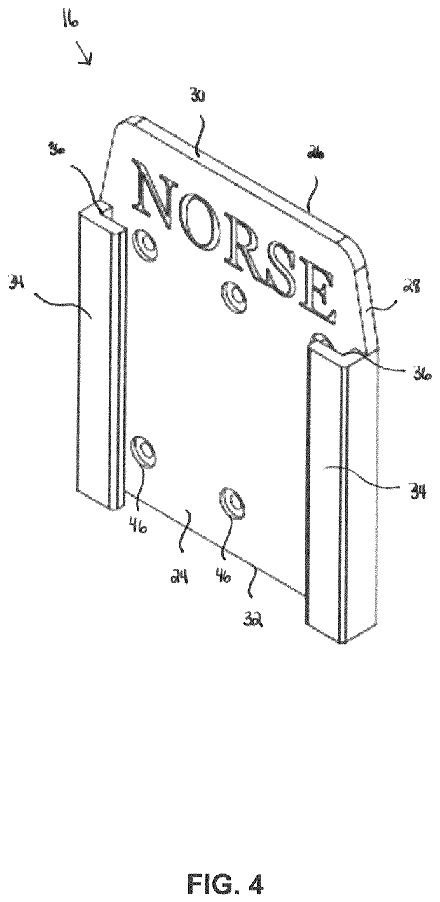

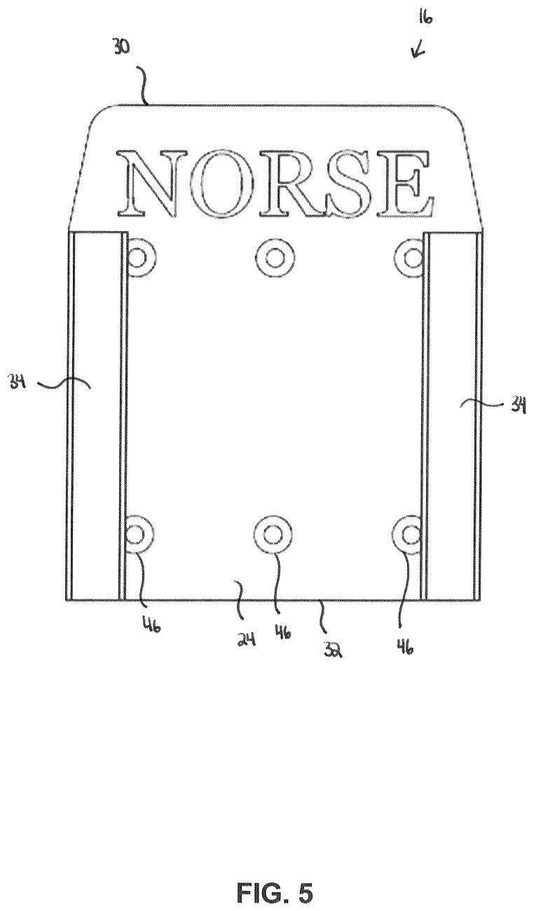

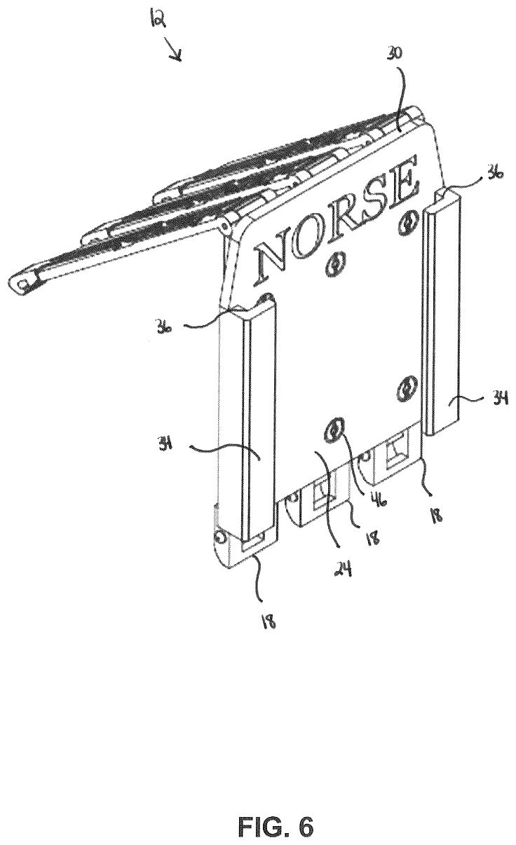

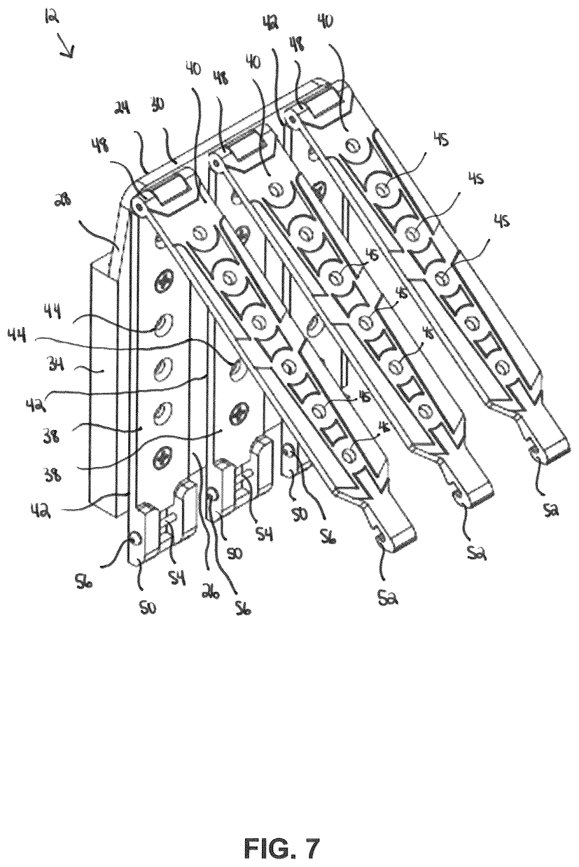

Referring now to FIGS. 4-7, the backplate 16 of the backplate assembly 12 includes a substantially flat front surface 24, a substantially flat rear surface 26, and at least one side 28 extending between the front surface 24 and the rear surface 26. In some embodiments, the backplate includes a top 30, a bottom 32, and two parallel sides 28 extending between the front surface 24 and the rear surface 26. The front surface 24 includes two spaced apart rails 34 extending parallel to each other along the sides 28, each rail 34 including a groove 36 extending substantially the length of the rail 34.

The backplate assembly 12 further includes at least one mounting member 18, and in the depicted embodiment, includes three mounting members 18. In the depicted embodiment, the mounting members 18 each include a first elongated element 38 and a second elongated element 40 hingedly attached to the first elongated element 38. The first elongated element 38 includes a rear surface 42 attached to the rear surface 26 of the backplate 16. In the depicted embodiment, each first elongated member 38 includes one or more apertures 44, and the backplate 16 includes one or more corresponding apertures 46 in the front and rear surfaces 24, 26 of the backplate 16. In the depicted embodiment, the first elongated element 38 of each mounting member 18 includes six apertures 44, and the front and rear surfaces 24, 26 of the backplate 16 includes six apertures 46. In the depicted embodiment, each mounting member 18 includes a first end 48 attached to the rear surface 26 of the backplate 16 and an opposite end 50 unattached to the rear surface 26 of the backplate 16. In the depicted embodiment, each second elongated element 40 includes a hook element 52 and each first elongated element 38 includes a corresponding bar element 54 configured to receive and retain the hook element 52. The mechanical engagement between the hook element 52 and bar element 54 secures the second elongated element 38 in a closed position and prevents the second elongated element 38 from unintentionally opening during use. The mounting member 18 further includes one or more release elements 56 which enable a user to intentionally disengage the hook element 52 from the bar element 54. The release elements 56 are biased into a locked position and when depressed by the user permits release of the hook element 52 from the bar element 54. In some embodiments, the release elements 56 may comprise a spring-loaded actuator or cam mechanism. In certain embodiments, the backplate 16 may further include indicia, shown here as the word “NORSE,” indicating the source of the modular tool carrier 10 or indicating the identity of the wearer (e.g., “POLICE,” “SWAT,” or the individual wearer's name). In some embodiments, the backplate assembly 12 can be individual pieces as described herein or molded as a unit.

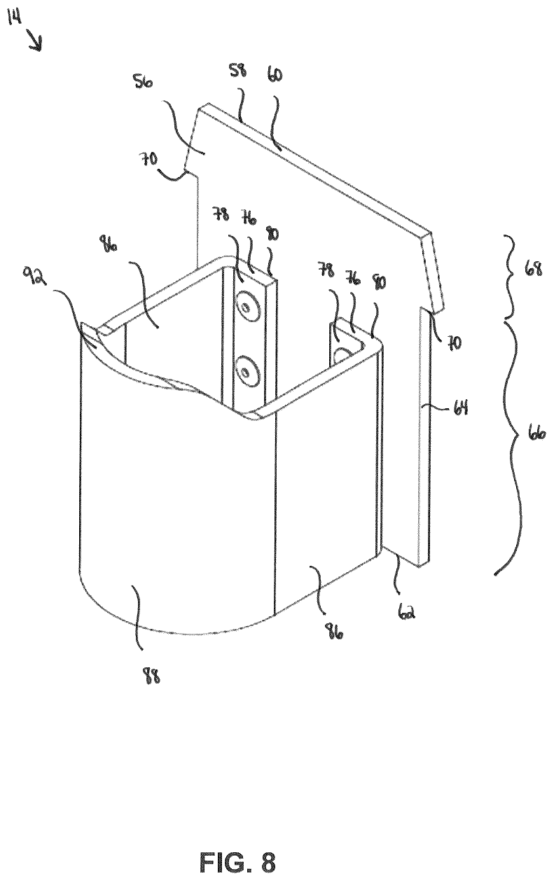

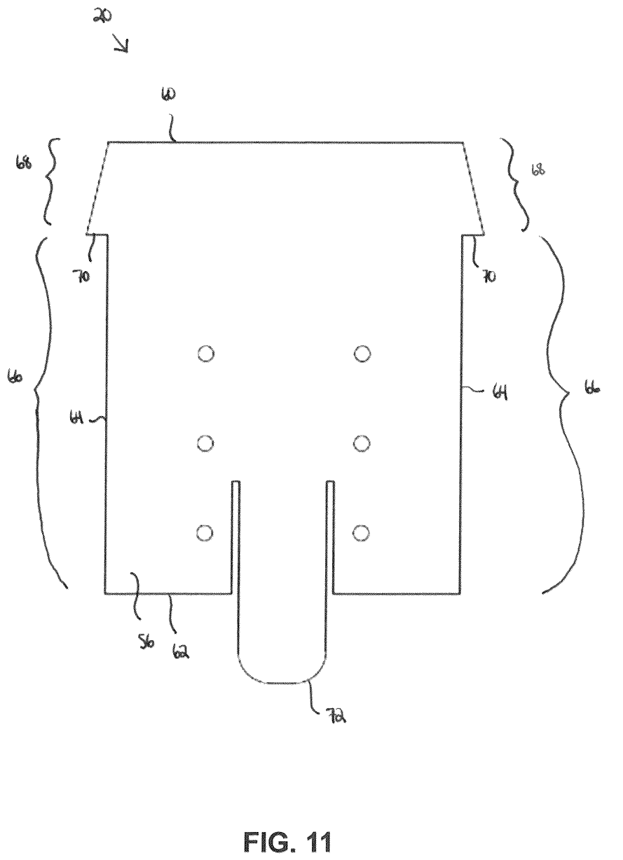

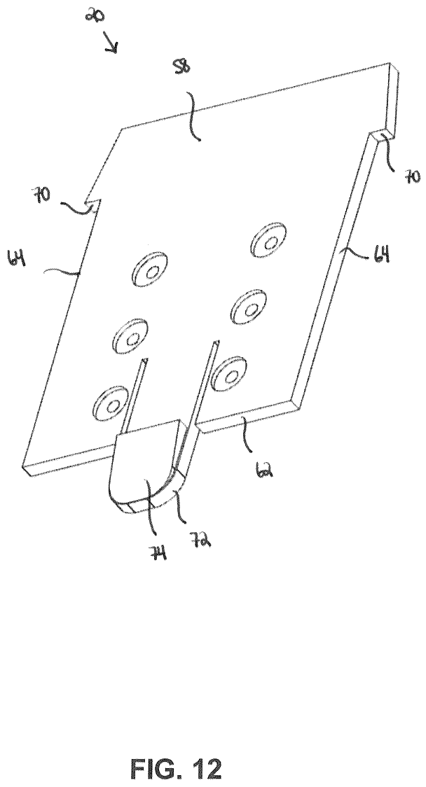

Referring now to FIGS. 8-12, the holster attachment plate 20 has a substantially flat front surface 56, a substantially flat rear surface 58, a top 60, a bottom 62, and two sides 64 extending between the front surface 56 and the rear surface 58. Each side 64 includes a lower portion 66 adjacent the bottom 62 and an upper portion 68 adjacent the top 60. As most easily seen in FIGS. 11 and 12, the width of the holster attachment plate 20 increases at the interface between the upper portion 68 of the side 64 and the lower portion 66 of the side 64, forming a stop 70. The holster attachment plate 20 further includes a retaining element 72 extending past the bottom 62, the retaining element 72 including a raised block 74 on the rear surface 58. The raised block 74 may be removably or fixedly attached to the retaining element 72.

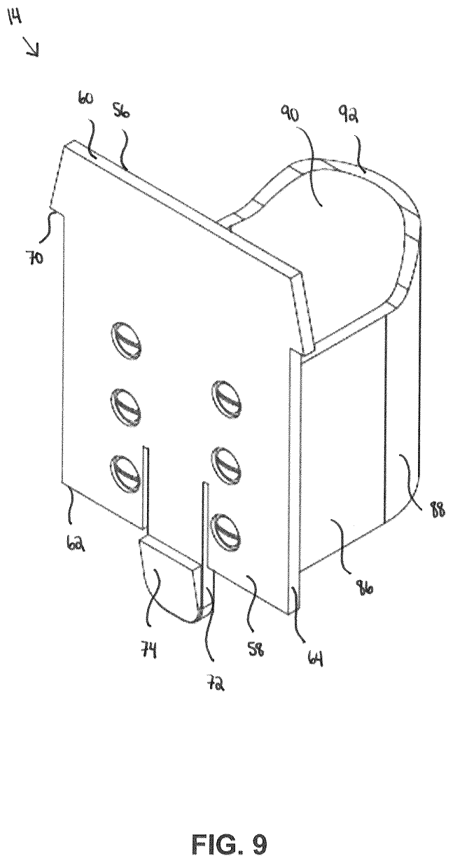

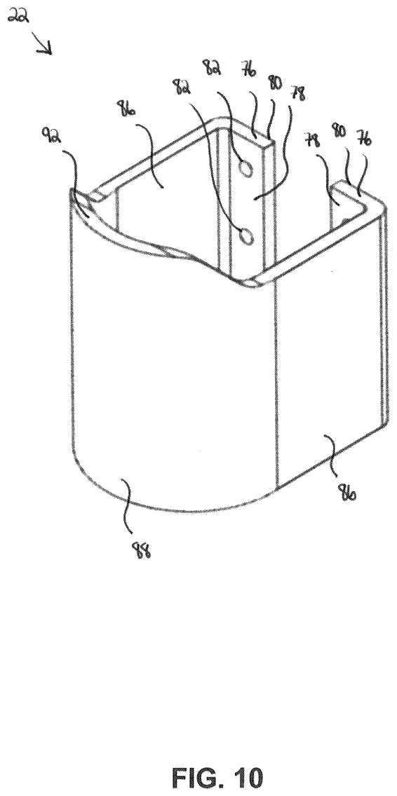

In the depicted embodiment, the holster 22 includes two substantially parallel and substantially vertical back walls 76 defining a gap therebetween, each back wall 76 having a substantially flat front surface 78 and a substantially flat rear surface 80. In the depicted embodiment, each back wall 76 includes one or more apertures 82, and the holster attachment plate 20 includes one or more corresponding apertures 84 in the front and rear surfaces 56, 58 of the holster attachment plate 20. The holster 22 may be removably attached to the holster attachment plate 20 by inserting one or more fasteners, such as screws, through apertures 84 in the holster attachment plate 20 into corresponding apertures 82 in the back walls 76 of the holster 22. In the depicted embodiment, the back walls 76 each include three apertures 82 and the front and rear surfaces 56, 58 of the holster attachment plate include six apertures 84. The holster 22 further includes two spaced apart sidewalls 86 extending substantially perpendicular from the back walls 76. The sidewalls 86 extend substantially parallel to each other and are connected to each other opposite the back walls 76 by a convex front portion 88 extending between the sidewalls 86. The front surface 78 of the back walls 76, the sidewalls 86, and the convex front portion 88 cooperatively form a vertical channel 90 for holding a tool. As most easily seen in FIGS. 9 and 10, the convex front portion 88 extends above the sidewalls 86, forming a saddle shape 92 for retaining the tool. In some embodiments, the tool holder 14 can be individual pieces as described herein or molded as a unit.

The backplate assembly 12, including backplate 16 and mounting members 18, is configured to mount on a tactical vest, harness, or other wearable load-bearing element. Many tactical vests (not pictured) include webbing (i.e., a series of bands of woven material for attaching equipment and/or accessories to the vests). The backplate assembly 12 is configured for removable attachment to a tactical vest by sliding the webbing between the first elongated element 38 and the second elongated element 40 of each mounting member 18. The webbing can be secured in each mounting member 18 by engaging the bar element 54 with the hook element 52.

In the event the wearer expects to engage in vigorous movement, the backplate assembly 12 can be further secured to the tactical vest by inserting fasteners (not shown), such as screws, through apertures 45 in the second elongated member 40 of the mounting member 18 into corresponding apertures 44 in the first elongated member 38 of the mounting member 18.

Once the backplate assembly 12 is attached to the tactical vest, the modular tool carrier 10 may be assembled by removably attaching the tool holder 14 to the backplate assembly 12. The tool holder 14 is removably attached to the backplate assembly 12 by slidably inserting the lower portion 66 of the sides 64 of the holster attachment plate 20 of the tool holder 14 into and between the corresponding grooves 36 in the rails 34 of the backplate 16, such that the substantially flat rear surface 58 of the holster attachment plate 20 of the tool holder 14 is adjacent the substantially flat front surface 24 of the backplate 16 of the backplate assembly 12. The holster attachment plate 20 is slid downward between the rails 34 until the stops 70 contact the rails 34 preventing further downward movement of the tool holder 14 with respect to the backplate assembly 12. The raised block 74 on the retaining element 72 of the holster attachment plate 20 fits over and engages the bottom 32 of the backplate 16, preventing upward movement of the tool holder 14 with respect to the backplate assembly 12. To remove the tool holder 14 from the backplate assembly 12, an individual may pull the retaining element 72 in a rearward direction, disengaging the raised block 74 from the bottom 32 of the backplate 16, and allowing the tool holder 14 to be slid upwards with respect to the backplate assembly 12 and exit the rails 34.

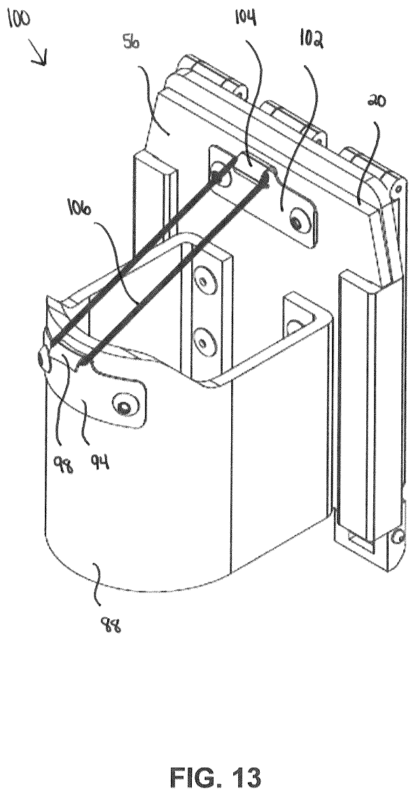

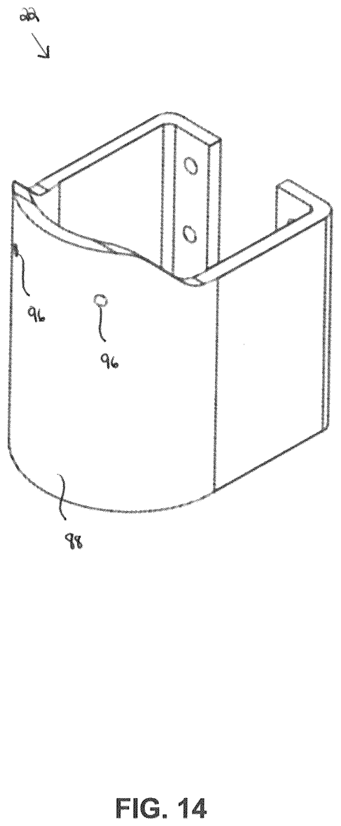

A second embodiment of a modular tool carrier 100 is shown in FIGS. 13 and 14. The modular tool carrier 100 further includes a first cordage attachment plate 94 on the convex front portion 88 of the holster 22. The first cordage attachment plate 94 may be removably attached to the convex front portion 88 by inserting one or more fasteners through apertures (not pictured) in the first cordage attachment plate 94 into corresponding apertures 96 in the convex front portion 88 of the holster 22. The first cordage attachment plate 94 further includes a horizontal channel 98 extending partially across the width of the first cordage attachment plate 94. In some embodiments, the first cordage attachment plate 94 has a contour that is complementary to the contour of the convex front portion 88 such that the first cordage attachment plate 94 abuts the convex front portion 88 with little to no space between the first cordage attachment plate 94 and the convex front portion 88.

The modular tool carrier 100 further includes a second cordage attachment plate 102 on the front surface 56 of the holster attachment plate 20. The second cordage attachment plate may be removably attached to the holster attachment plate 20 by inserting one or more fasteners through apertures (not pictured) in the second cordage attachment plate 102 into corresponding apertures (not shown) in the front and rear surfaces 56, 58 of the holster attachment plate 20. The second cordage attachment plate 102 further includes a horizontal channel 104 extending partially across the width of the second cordage attachment plate 102. In some embodiments, the second cordage attachment plate 102 is substantially flat such that the second cordage attachment plate 102 abuts the front surface 56 of the holster attachment plate 20 with little to no gap between the second cordage attachment plate 102 and the front surface 56 of the holster attachment plate 20.

To assist in retaining a tool in the modular tool carrier 100, a rope, bungee cord, strap, string, or similar device in the form of a closed loop 106 may be extended over and/or wrapped around the top or head of a tool (not pictured) and may be received and retained by the horizontal channel 98 on the first cordage attachment plate 94 and the horizontal channel 104 on the second cordage attachment plate 102. Such additional assistance in retaining a tool in the modular tool carrier 100 may be warranted when the individual carrying the tool expects to engage in dynamic movements such as running, climbing, rappelling, and the like.

In use, an individual may remain comfortably seated in a vehicle with the backplate assembly 12 secured to the individual's tactical vest and a breaching or breaking tool can be separately retained within the tool holder 14. The substantially flat profile of the backplate assembly 12 allows an individual wearing the backplate assembly 12 to comfortably rest against a seat back. When the individual is ready to exit the vehicle, the tool holder 14 can be slidably engaged and received by the backplate 16 to assemble the modular tool carrier 10 and quickly mount a tool onto the individual. In some embodiments, a separate backplate 16 may be attached to the interior of a vehicle, such that the tool holder 14 can be attached to the vehicle-mounted backplate 16 for storage of a tool, and the tool holder 14 moved to the backplate assembly 12 mounted on the individual's vest when the time for action arrives.

While examples, one or more representative embodiments, and specific forms of the invention have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

What is claimed is:

1. A modular tool carrier, comprising:
a tool holder including
a holster attachment plate having a substantially flat front surface, a substantially flat rear surface, a top, a bottom, and two sides extending between the front surface and the rear surface; and
a holster having at least one back wall, said back wall having a substantially flat front surface and a substantially flat rear surface; said holster further including two spaced apart sidewalls extending substantially perpendicular from the at least one back wall, the sidewalls extending parallel to each other, the sidewalls being connected by a convex front portion extending between the sidewalls;
wherein the holster is attached to the holster attachment plate and wherein the front surface of the holster attachment plate, and where the sidewalls and the convex front portion of the holster cooperatively form a channel for holding a tool.

2. The modular tool carrier of claim 1, further comprising:
a backplate assembly including
a backplate body having a substantially flat front surface, a substantially flat rear surface, and at least one side extending between the front surface and the rear surface; and
two spaced apart rails on the front surface, the rails extending parallel to each other;
wherein the rails are configured to removably receive and slidably engage the sides of the holster attachment plate.

3. The modular tool carrier of claim 2, the backplate assembly further comprising at least one mounting member attached to the rear surface of the backplate body.

4. The modular tool carrier of claim 3, wherein the at least one mounting member includes a first elongated member and a second elongated member, wherein the first and second elongated members are hingedly attached at a first end of the mounting member.

5. The modular tool carrier of claim 4, wherein the first elongated member and the second elongated member are configured to mechanically engage at a second end of the mounting member opposite the first end.

6. The modular tool carrier of claim 5, wherein the first elongated member further comprises a bar-shaped member and wherein the second elongated member includes a hook-shaped member, and wherein the hook shaped member of the second elongated member mechanically engages the bar-shaped member of the first elongated member.

7. The modular tool carrier of claim 6, wherein the first elongated member further comprises at least one spring-loaded release button that mechanically disengages the hook element from the bar element when depressed by a user.

8. The modular tool carrier of claim 3, wherein the backplate body includes at least one aperture, and wherein the at least one mounting member includes, for each aperture in the backplate body, a corresponding aperture in the at least one mounting member; and wherein a fastener extending into the aperture in the backplate body and the corresponding aperture in the at least one mounting member mechanically secures the at least one mounting member to the backplate body.

9. The modular tool carrier of claim 1, wherein the holster attachment plate includes a retaining element extending past the bottom of the holster attachment plate, the retaining element including a raised block on the rear surface of the retaining element.

10. The modular tool carrier of claim 1, wherein the holster of the tool holder includes a protrusion extending from the convex front portion of the tool holder.

11. The modular tool carrier of claim 10, wherein the protrusion comprises a horizontal channel configured to receive a length of cordage.

12. The modular tool carrier of claim 2, wherein the sides of the holster attachment plate of the tool holder each include a lower portion adjacent the bottom of the holster attachment plate and an upper portion adjacent the top of the holster attachment plate, and wherein the width of the upper portion is greater than the width of the lower portion.

13. The modular tool carrier of claim 12, wherein an interface between the lower portion of the holster attachment plate and the upper portion of the holster attachment plate creates a stop that contacts the rails of the backplate.

14. The modular tool carrier of claim 2, wherein the front surface of the holster attachment plate includes a protrusion extending from the front surface of the holster attachment plate.

15. The modular tool carrier of claim 14, wherein the protrusion comprises a horizontal channel configured to receive a length of cordage.

16. The modular tool carrier of claim 2, wherein the holster of the tool holder includes a protrusion extending from the convex front portion of the tool holder, and wherein the front surface of the holster attachment plate includes a protrusion extending from the front surface of the holster attachment plate.

17. The modular tool carrier of claim 16, wherein the protrusion extending from the convex front portion of the tool holder and the protrusion extending from the front surface of the holster attachment plate each comprise a horizontal channel configured to receive a length of cordage.
